(19) United States
(12) Patent Application Publication
(10) Pub. No.: US 2025/0303470 A1
(43) Pub. Date: Oct. 2, 2025

(54) ADDITIVE MANUFACTURING APPARATUS AND METHOD

(71) Applicant: RENISHAW PLC, Wotton-under-Edge, Gloucestershire (GB)

(72) Inventors: Nicholas Henry Hannaford JONES, Wotton-under-Edge (GB); John DARDIS, Wotton-under-Edge (GB); Benjamin Philip COLLINS, Wotton-under-Edge (GB); Eleanor Rose PARKER, Wotton-under-Edge (GB)

(73) Assignee: RENISHAW PLC, Wotton-under-Edge, Gloucestershire (GB)

(21) Appl. No.: 18/863,546

(22) PCT Filed: May 17, 2023
(86) PCT No.: PCT/GB2023/051300

§ 371 Date: Nov. 6, 2024

(30) Foreign Application Priority Data
May 23, 2022 (GB) 2207531.1

(51) Int. Cl. B22F 10/36; B22F 10/28; B22F 10/85; B22F 12/45; B22F 12/90; B33Y 10/00; B33Y 30/00; B33Y 50/02

(52) U.S. Cl. CPC B22F 10/36; B22F 10/28; B22F 10/85; B22F 12/45; B22F 12/90; B33Y 10/00; B33Y 30/00; B33Y 50/02; B22F 2998/10

(57) ABSTRACT

A method and an additive manufacturing apparatus including a device for generating an energy beam for consolidating a build medium and a build chamber, the build chamber including a build chamber window through which the energy beam may enter the build chamber and a build area where the build medium can be located to be consolidated by the energy beam, wherein the additive manufacturing apparatus is configured to monitor process emissions from the build area to detect damage of the build chamber window.

The invention of the current application relates to an additive manufacturing apparatus and a method of determining damage thereto, in particular of a build chamber window of an additive manufacturing apparatus.

Additive manufacturing or rapid prototyping methods for producing objects comprise layer-by-layer solidification of a material, such as a metal powder material using an energy beam, for example a laser beam. A powder layer is deposited on a powder bed in a build chamber and a laser beam is scanned across portions of the powder layer that correspond to a cross-section of the object being constructed. The laser beam melts or sinters the powder to form a solidified layer. After selective solidification of a layer, the powder bed is lowered by a thickness of the newly solidified layer and a further layer of powder is spread over the surface and solidified, as required.

During the additive manufacturing process, it is known that particulate matter (also often known as, for example fume, black smoke, spatter, or bright sparks) can be produced. This material can adhere to surfaces within the apparatus, and in particular can adhere to a build chamber window. Adherence to the build chamber window can reduce the quality of parts manufactured by the apparatus.

US 2017/355147 discloses a machine having a first energy source delivering a beam of energy which can enter a build chamber through a window in the build chamber to consolidate powder which forms part of a powder bed. A second energy source is provided which continuously or at discrete intervals monitors the reflectivity of the window during the build. At least one detector is provided internal and/or external the build chamber to detect changes in the energy beam from the second energy source due to changes in reflectivity of the window. If the change in reflectivity of the window is detected to be above a threshold the build is aborted or stalled until the reflectivity is within tolerance, this may be achieved by cleaning the window.

US 2020/114580 discloses an arrangement for determining a degree of contamination of an optical unit, such as a rectangular window. The arrangement comprises a light source provided in a wall of a process chamber and adapted to couple radiation into the optical unit towards a central plane of the optical unit, a determination unit is also provided. Residues adhered to the surface of the optical unit can cause at least part of the radiation to be decoupled from the optical unit and be detected by a detector of the determination unit.

US 2015/0165681 discloses providing a laser power meter within a build chamber near the build surface. The energy source can be controlled based on the power of the energy beam measured within the build chamber.

US 2022/0111599 discloses a method comprising using image data from a light sensor that detects a reflected portion of an imaging beam from an optical element to determine anomalies on the optical element.

US 2018/126649 discloses a method to quantify the effectiveness of recessed window holders with gas flow purging.

WO 2019/173000 discloses a method where a change in spot size at a target surface may generate an alert, message, and/or initiate a purging and/or cleaning cycle.

According to a first aspect there is provided a method of detecting damage of a build chamber window of an additive manufacturing apparatus, the additive manufacturing apparatus comprising a build chamber comprising the build chamber window through which an energy beam may enter the build chamber and a build area where a build medium can be located to be consolidated by the energy beam, the method comprising monitoring the intensity of process emissions from the build area.

Monitoring the intensity of process emissions may comprise recording the intensity of process emissions. The process emissions may be emissions created by the interaction of the energy beam with the build area and/or powder bed, for example monitoring the process emissions may comprise monitoring electromagnetic radiation, for example from plasma. Monitoring the intensity of process emissions from the build area may be carried out by monitoring a wavelength different from the wavelength of the energy beam. Optionally a wavelength shorter than the wavelength of the energy beam may be used for monitoring the intensity of process emissions. Optionally a wavelength longer than the wavelength of the energy beam may be used for monitoring the intensity of the process emissions. Optionally a first wavelength shorter than the wavelength of the energy beam and a second wavelength longer than the wavelength of the energy beam may be provided used for monitoring the intensity of the process emissions. Monitoring the intensity of process emissions may be carried out by one or more photo diodes, for example one or more photodiodes sensitive to a wavelength different from the wavelength of the energy beam. Optionally a photodiode sensitive to a wavelength shorter than the wavelength of the energy beam may be used for monitoring the intensity of the process emissions. Optionally a photodiode sensitive to a wavelength longer than the wavelength of the energy beam may be used for monitoring the intensity of the process emissions. Optionally a first photodiode sensitive to a wavelength shorter than the wavelength of the energy beam may be provided and a second photodiode sensitive to a wavelength longer than the wavelength of the energy beam may be provided used for monitoring the process emissions. Process emissions may comprise plasma generated by interaction of the laser beam with the build area. Optionally monitoring occurs while the energy beam is firing. Additionally or alternatively, monitoring occurs when the energy beam is not firing.

Optionally the method comprises monitoring the entire build area. The energy beam may be a laser beam, or an electron beam. Damage may include contamination of the build chamber window, for example, material from a manufacturing process solidifying on the chamber side surface of the build chamber window. Additionally or alternatively, damage may comprise other contamination of the build chamber window by fingerprints, and/or dirt, and/or dust, and/or contamination with other organic or metallic substances. Additionally or alternatively, damage may comprise one or more cracks and/or one or more scratches, and/or other physical flaws and/or defects of the build chamber window itself, other examples of physical defects or flaws may include local deformation of the build chamber window such as swelling, and/or any other flaw which causes a reduction in optical transmittance and/or change the energy absorption of the build chamber window (for example increase the amount of energy the build chamber window absorbs from the energy beam) and/or change in optical properties of the build chamber window. Damage may result in thermal lensing which may be due to a change in energy absorption by the build chamber window due to the damage. Thermal lensing may also cause a rapid, unstable change in the path of the laser beam as the laser beam passes through the build chamber window, this may cause the location where the laser beam contacts the build area (as well as the area which is observed by a monitoring system) to vary rapidly which prevents or reduces energy absorption due to movement of the energy beam (in such situations the intensity of the energy beam may not change but a reduction in process emissions may be observed due to the movement of the energy beam on the build area preventing or reducing the integration of the energy beam energy into the surface).

Optionally the build area comprises the area in which a part can be built. Optionally the build area comprises the area where a powder bed can be formed. Optionally the additive manufacturing apparatus comprises a support for supporting a powder bed. Optionally the build area comprises the area of the support and/or within the periphery of the support and on a support for supporting a powder bed (for example, a build plate). Optionally the build area comprises a surface (optionally an uppermost surface) within the periphery of the support (for example, a build plate and/or a powder bed). This can allow monitoring of the support for supporting the powder bed or monitoring anything located on the support, for example the powder bed, or a plate located on the support, or a wiper which may be provided in order to apply powder to the build area in order to form a powder bed, or any other device or means provided within the periphery of the support.

Optionally the build chamber window has one face which is exposed to the inside of the build chamber. Optionally the build chamber window separates one or more components of the energy beam system from the conditions within the build chamber. Optionally the build chamber window is transparent to the energy beam. Optionally the build area comprises a surface (optionally an uppermost surface) within the periphery of the support and which surface is located between the support and the face of the build chamber window which is exposed to the inside of the build chamber. Optionally the build area comprises a surface (optionally a surface within the build chamber) which is located on the build chamber side of the face of the build chamber window which is exposed to the inside of the build chamber. Optionally the surface does not include the face of the build chamber window which is exposed to the inside of the build chamber.

Optionally the build chamber window forms part of one or more walls which form the build chamber. Optionally the build chamber window is entirely located within the build chamber and may form part of a module within the build chamber, for example an optical module located within the build chamber. Optionally the build chamber window is arranged to allow the energy beams to enter the build chamber. Optionally the build chamber window is constructed from a material which allows light to pass therethrough. Optionally more than one build chamber window is provided.

Advantageously it is known to provide an additive manufacturing with apparatus for monitoring the build area of the apparatus, this allows the method to be carried out without additional parts, or complexity of assembly when building the additive manufacturing apparatus. The method may advantageously be applied to already existing additive manufacturing apparatus retrospectively without additional parts being fitted. It is further advantageous that by using the energy beam, which is for consolidating the build medium, it is possible to analyse all locations of the build chamber window through which the energy beam may pass when consolidating build material within the build area.

Optionally the energy beam is monitored by a sensor wherein the optical path of radiation collected by the sensor from the build area is at least partially coincident with the path of the energy beam.

Optionally the method comprises comparing data from locations of the build area to a threshold. The data may be at least one of (i) a normalised data set, and/or (ii) spatial extent of data, and/or (iii) density of defects. Optionally the data comprises data different from a threshold, optionally below a threshold. Alternatively, the data comprises data above a threshold.

The method may comprise identifying locations of the build area where the process emission intensity is different from a threshold. Optionally the method comprises identifying locations of the build area where the process emission intensity is below a threshold value. The method may be carried out prior to building a part. The method may comprise determining a “go/no-go” state for building a part. Advantageously by determining a “go/no-go” state the method can save unnecessarily wasting build material and/or time because a part build does not meet the required specification due to the damaged build chamber window. Alternatively, if damage to the build chamber window is identified mid-way through a build process, the build may have to be terminated which can mean build material has been wasted partially making a part. Alternatively if damage to the build chamber window is identified mid-way through a build, it may be possible to (i) replace or (ii) clean the build chamber window without terminating the build, however (i) replacing the build chamber window can mean exposing the inside of the build chamber to potential contamination when the damaged build chamber window is removed in the case where the build chamber window is replaced, and (ii) it may not be possible to remove the damage to the build chamber window by cleaning, for example where the damage to the build chamber window is a crack or similar. Performing the method before the build and producing a “go/no-go” signal can reduce or even prevent the need to terminate a build part way though due to identification of damage to the build chamber window, can save unnecessary waste of build material, and can help reassure a user that a build will not fail due to damage to the build chamber window.

The method may rearrange location of a part to be built within the build area in response to detected damage of the build chamber window. This can allow a build to proceed when damage to the build chamber window is identified but without having to wait for the build chamber window to be cleaned or replaced. By rearranging the locations of a part to be built within the build area it may be possible to produce the parts without the energy beam entering the build chamber through a damaged section of the build chamber window.

Optionally the method comprises monitoring the intensity of process emissions created by a plurality of energy beams on the build area. The method may comprise scanning the build area with the plurality of energy beams such that each energy beam irradiates 1/n of the build area, where n is the number of energy beams, optionally the build area is scanned at least n times such that each of the n laser beams scans the entire build area. The method may comprise scanning the entire build area with each of the plurality of energy beams. Optionally the method comprises monitoring the intensity of process emissions created by two or more energy beams on the build area at the same time. The method may comprise monitoring the process emission intensity created by all of the plurality of energy beams on the build area at the same time. The method may comprise dividing the build area into a number of sections, wherein each discrete section is irradiated by one of the plurality of the energy beams, and wherein the number of discrete areas is greater than the number of energy beams. Optionally adjacent discrete sections are irradiated by different energy beams. Advantageously this can allow for discrimination between damage to the build chamber window and other factors, for example factors which arise from features of the build area. Optionally the method comprises monitoring the process emission intensity created by a plurality of energy beams for the same part of the build area, for example sequentially monitoring the process emission intensity created by a plurality of energy beams on the same part of the build area (i.e., monitoring the process emission intensity created by a first of a plurality of energy beams on a part of the build area, before monitoring the process emission intensity created by a second of a plurality of energy beams for the same part of the build area). By monitoring the process emission intensity created by a plurality of energy beams for the same part of the build area it is possible to irradiate the same part (or location) of the build area while passing an energy beam through a different location of the build chamber window, which can provide information related to whether detected damage is related to the build chamber window or the build area.

The method may change the allocated energy beam used for building a part (or a portion(s) of a part) in response to detected damage of the build chamber window. This can allow the build to proceed when damage to the build chamber window is identified but without having to wait for the build chamber window to be cleaned or replaced. By changing energy beam allocation for a part (or a portion(s) thereof) to be built within the build area it may be possible to produce the part without the energy beam entering the build chamber through a damaged section of the build chamber window.

Optionally the energy beam or the plurality of energy beams are laser beams. Optionally the laser beams have an intensity of at least 150 W.

Optionally the method comprises a pre-clean step. The pre-clean step may comprise irradiating the build area with the energy beam in order to clean the build area prior to detecting damage to the build chamber window, for example, by removing (or burning off) organic or other substances on the build area. The pre-clean step may comprise irradiating the build area with the energy beam, optionally using an energy less than used during the step of monitoring the intensity of process emissions from the build area. Optionally the method comprises a build area homogenising step. The homogenising step may be carried out after the step of monitoring the intensity of process emissions from the build area. The homogenising step may comprise irradiating the build area with the energy beam in order to heal the build area surface, and/or reduce surface texture of the build area in order to improve powder delivery to the build area. Optionally the method comprises scanning the energy beam across the build area in a pattern for causing localised heating of a build chamber window. For example, a scan pattern comprising scanning adjacent rectangular sections of the build chamber window or build. Optionally the rectangular sections have a length in the range 1 mm to 10 mm (optionally 5 mm). Optionally the rectangular sections have a length of 10 mm or less. Optionally the rectangular sections have a width not wider than the width of the laser beam on the build chamber window or the build area.

According to a second aspect of invention there is provided a method of manufacturing a product comprising layer-by-layer consolidation by an energy beam of a build material in a build area located within a build chamber, the build chamber comprising a build chamber window through which the energy beam may enter the build chamber and a build area where the build medium can be located to be consolidated by the energy beam, the method comprising monitoring the process emissions from the build area. Optionally the method comprises monitoring the intensity of the process emissions.

According to a third aspect of invention there is provided an additive manufacturing apparatus comprising a device for generating an energy beam for consolidating a build medium and a build chamber, the build chamber comprising a build chamber window through which the energy beam may enter the build chamber and a build area where the build medium can be located to be consolidated by the energy beam, wherein the additive manufacturing apparatus is configured to monitor process emissions from the build area to detect damage of the build chamber window. Optionally the additive manufacturing apparatus comprises a device for monitoring the intensity of the process emissions. The device for monitoring intensity of the process emissions may be an on-axis monitoring device. Optionally the energy beam is a laser beam, or an electron beam. Optionally the additive manufacturing apparatus is configured to identify locations of the build area where intensity of the process emissions is different from a threshold value, optionally below a threshold value.

According to a fourth aspect of invention there is provided a method of detecting damage of a build chamber window of an additive manufacturing apparatus comprising indirect monitoring of an energy beam intensity. Optionally the energy beam comprises a laser beam.

According to a fifth aspect there is provided a method of detecting damage of a build chamber window of an additive manufacturing apparatus comprising monitoring a build area.

It will be understood that features described in relation to one aspect of invention can be applied to other aspects of invention unless incompatible.

Embodiments of the invention will now be described, by way of example only, with reference to the accompanying drawings, in which:

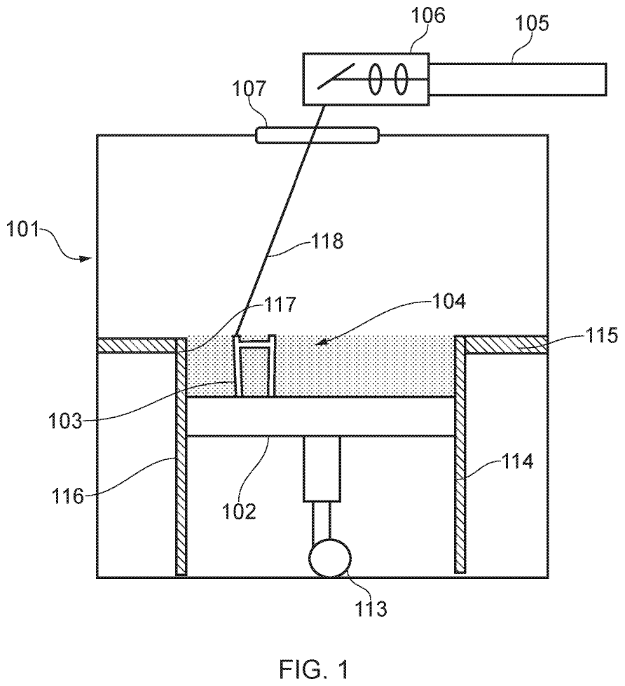

FIG. 1 shows a schematic of an additive manufacturing apparatus;

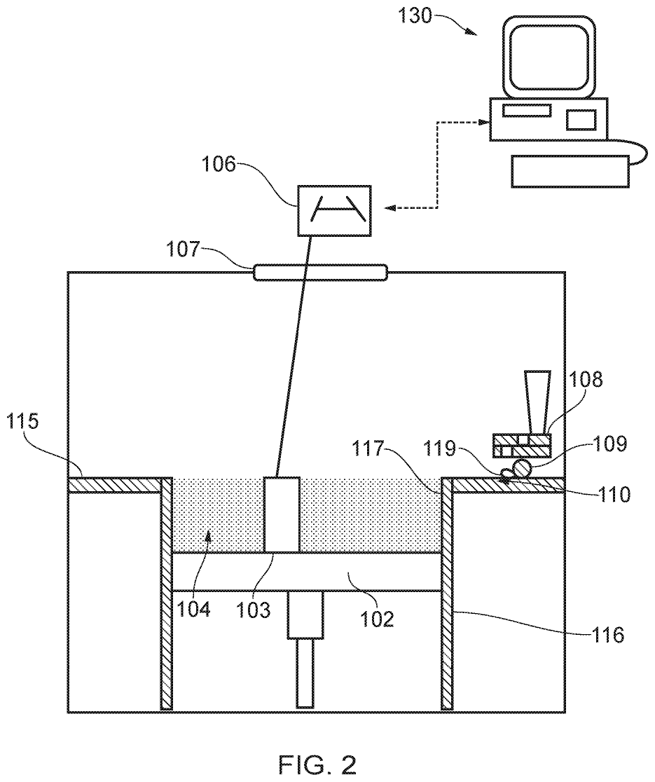

FIG. 2 shows a schematic view of the additive manufacturing apparatus of FIG. 1 from another side;

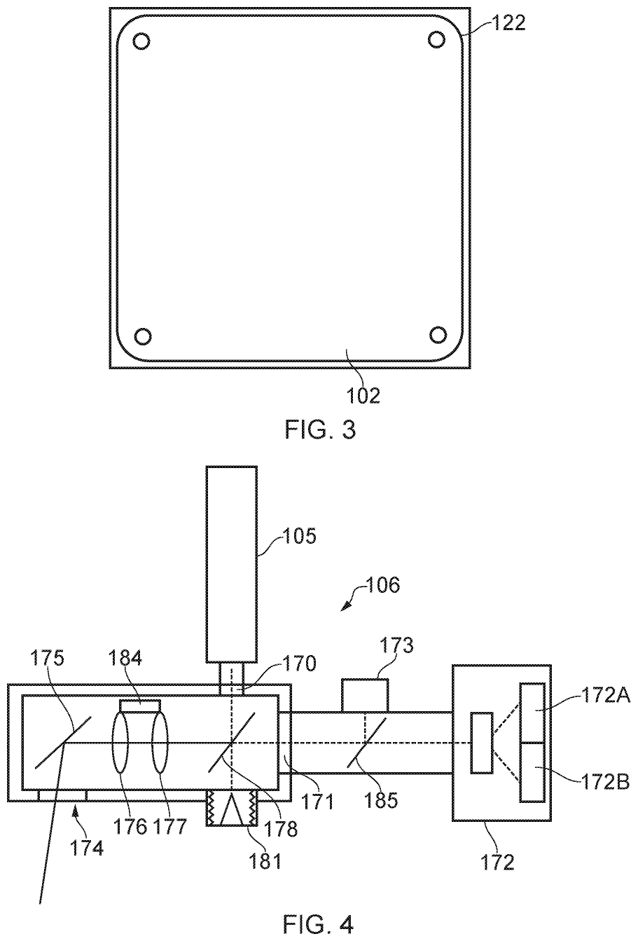

FIG. 3 shows a schematic view of a plan view of a build platform within a build area;

FIG. 4 shows an embodiment of an optical module;

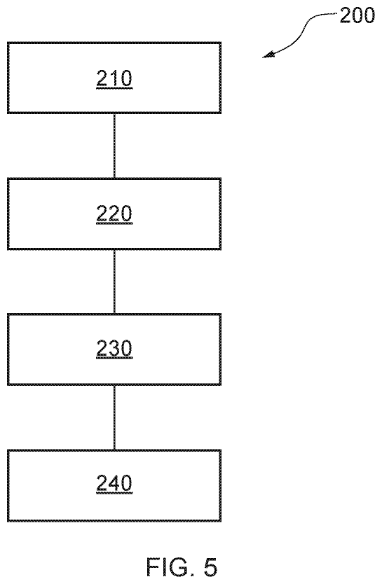

FIG. 5 shows a flow diagram illustrating the method;

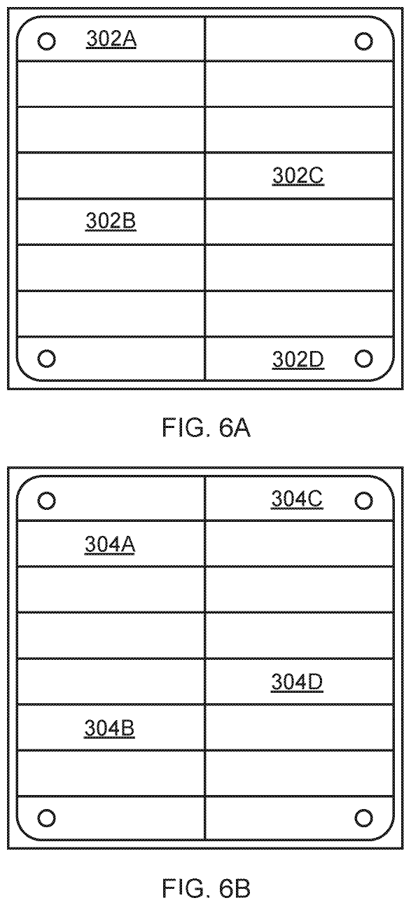

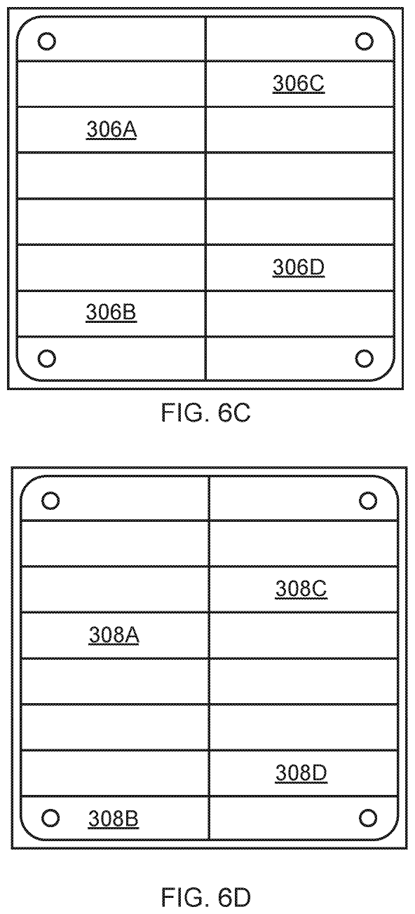

FIG. 6A-D shows sets of scan zones;

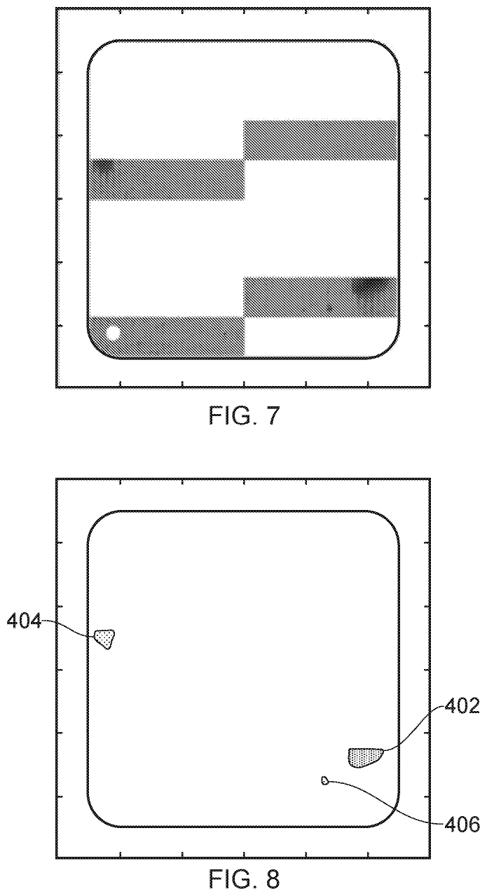

FIG. 7 shows an example of an accumulated data set;

FIG. 8 shows filtered data;

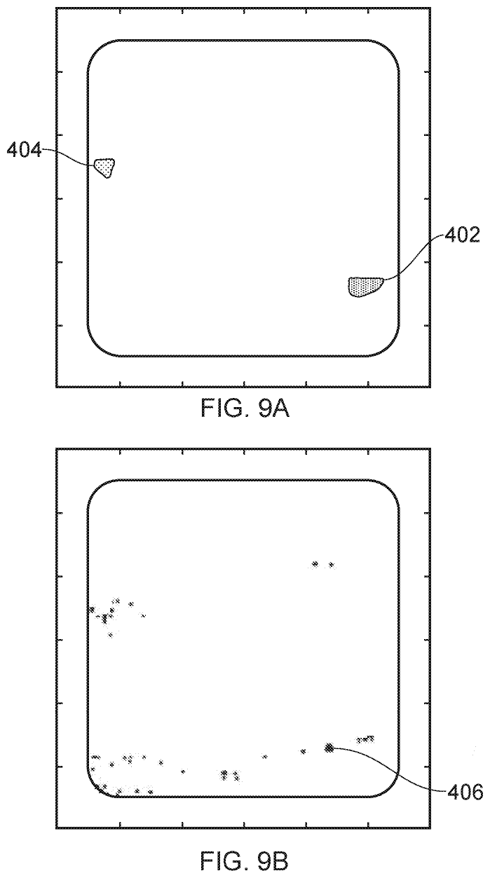

FIG. 9A shows cluster data;

FIG. 9B shows noise data;

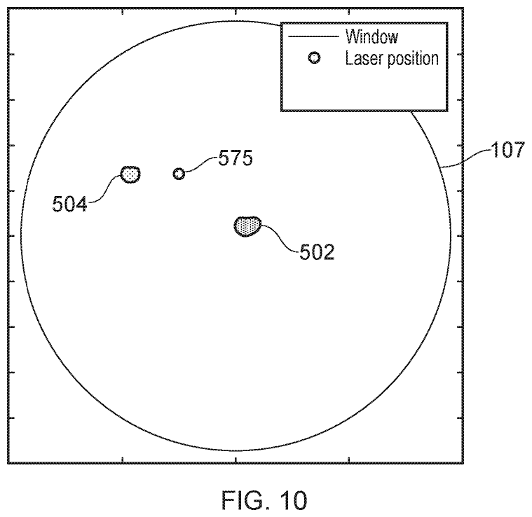

FIG. 10 shows a projection of where the laser beam passes though the build chamber window;

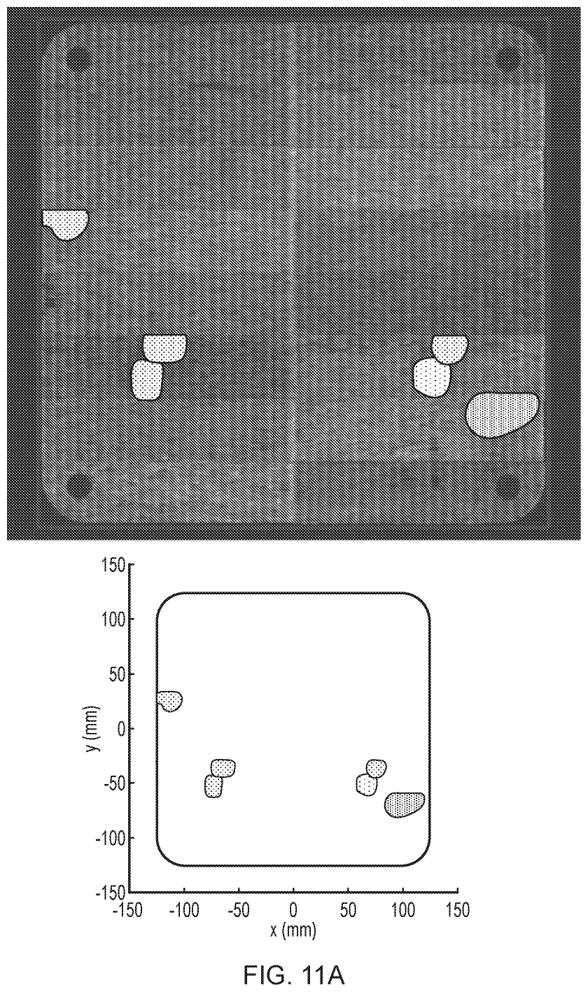

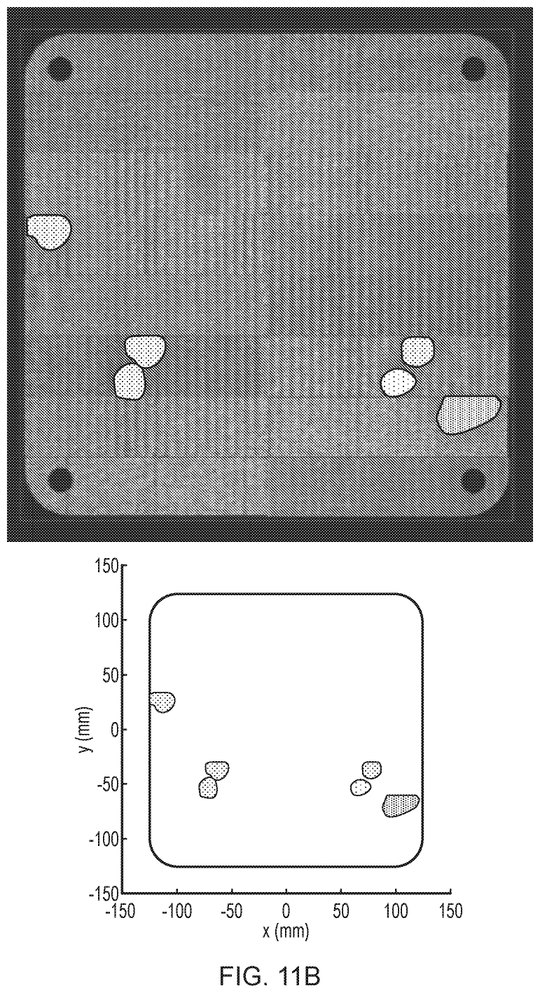

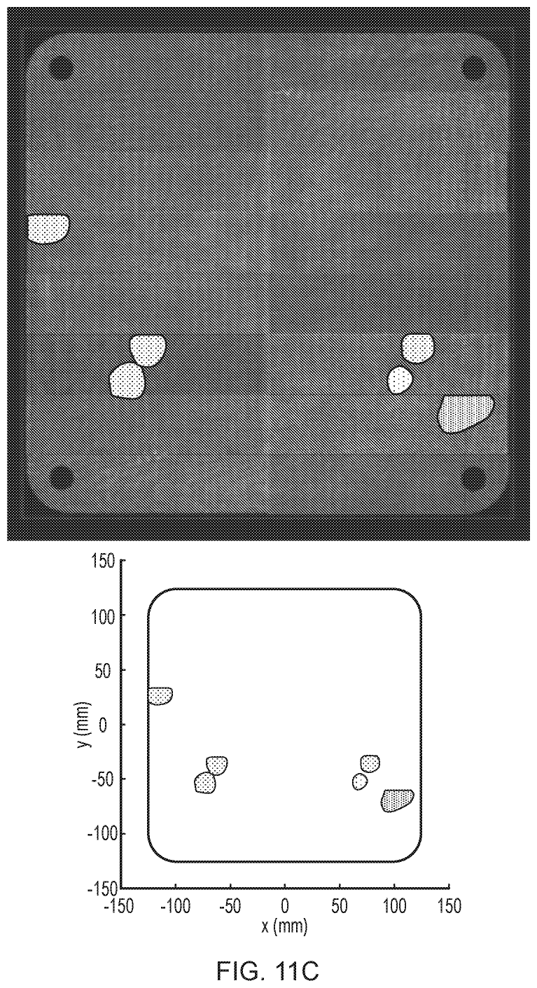

FIG. 11 shows data collected at different laser powers;

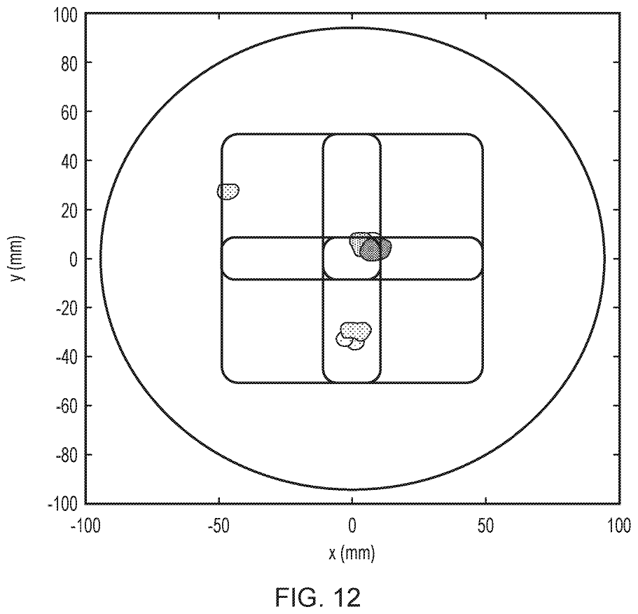

FIG. 12 shows cluster data projected onto the build chamber window;
And

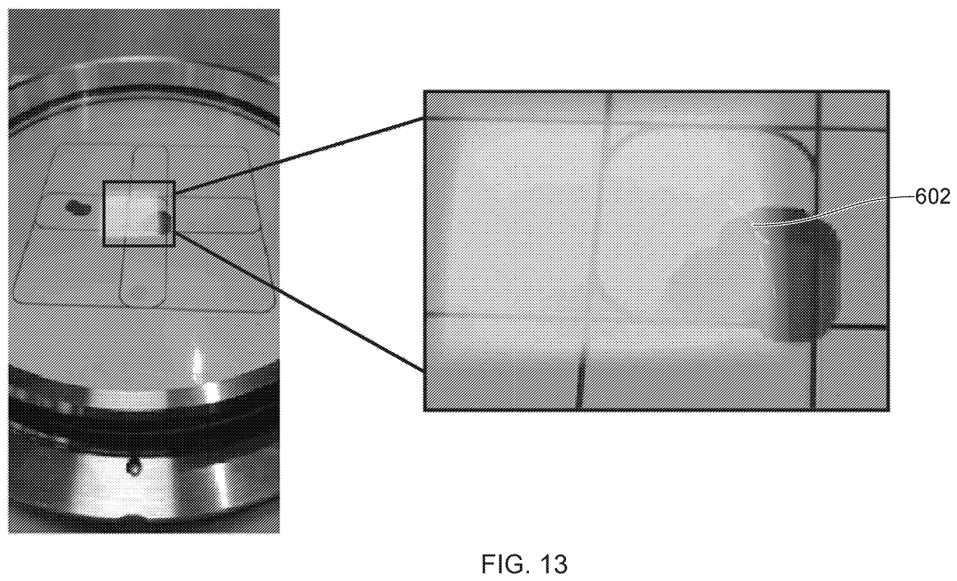

FIG. 13 shows a comparison between projected data and the build chamber window.

Referring to FIGS. 1 and 2, an additive manufacturing apparatus comprises a build chamber 101 having therein partitions 115, 116, which define a build area 122 and a surrounding surface 110 onto which powder can be deposited. A build platform 102 is provided within the boundaries of the build area 122 (seen more clearly in FIG. 3) for supporting a powder bed 104. A build volume 117 is defined by the extent to which the platform 102 can be lowered. An object/objects 103 can be built by selective laser melting powder 104. The build platform 102 can be lowered within the build volume 117 by a drive mechanism, such as a motor 113, as successive layers of the object 103 are formed. FIG. 3 shows a plan view of a build platform 102 located within a build area 122.

The build progresses by successively depositing layers of powder across the build area 122 in order to form the powder bed 104 using dispensing apparatus 108 for dosing the powder onto surface 110 and an elongate wiper 109 for spreading the powder across the build area 122. For example, the dispensing apparatus 108 may be apparatus as described in WO 2010/007396. The wiper 109 moves in a linear direction across the build platform 102.

A laser module 105 generates a laser for melting the powder 104, the laser directed as required by optical scanner 106 under the control of a computer 130. The laser beam 118 enters the chamber 101 via build chamber window 107. In this embodiment, the laser module 105 is a fibre laser, such as an nd:YAG fibre laser.

FIG. 4 shows an example optical module 106 for use in the current embodiment in detail. The optical module comprises a laser aperture 170 for coupling to the laser module 105, a measurement aperture 171 for coupling to measurement devices 172, 173 and output aperture 174 through which the laser beam is directed through build chamber window 107 on to the build area 122 and radiation emitted from the build area 122 is collected.

The laser beam is steered and focused to the required location on the powder bed 104 by scanning optics comprising two tiltable mirrors 175 (only one of which is shown) and focusing lenses 176, 177.

The tiltable mirrors 175 are each mounted for rotation about an axis under the control of an actuator, such as galvanometer. The axes about which the mirrors 175 are rotated are substantially perpendicular such that one mirror can deflect the laser beam in one direction (X-direction) and the other mirror can deflect the laser beam in a perpendicular direction (Y-direction). However, it will be understood that other arrangements could be used, such as a single mirror rotatable about two axes and/or the laser beam could be coupled, for example via an optical fibre, into beam director optics mounted for linear movement in the X- and Y-directions. Examples of this latter arrangement are disclosed in US2004/0094728 and US2013/0112672.

In order to ensure that a focus of the laser beam is maintained in the same plane for changes in a deflection angle of the laser beam it is known to provide an f-θ lens after tiltable mirrors. However, in this embodiment, a pair of movable lenses 176, 177 are provided before (relative to the direction of travel of the laser beam) the tiltable mirrors 175 for focusing the laser beam as the deflection angle changes. Movement of the focusing lenses 176, 177 is controlled synchronously with movement of the tiltable mirrors 175. The focusing lenses 176, 177 may be movable towards and away from each other in a linear direction by an actuator, such as a voice coil 184.

The tiltable mirrors 175 and focusing lenses 176, 177 are selected appropriately to transmit both the laser wavelength, and wavelengths of the collected radiation which can contain characteristic spectral peaks of the material being processed.

A beam splitter 178 is provided between the focusing lenses 176, 177 and the laser 105 and measuring devices 172, 173. The beam splitter 178 is a notch filter that reflects light of the laser wavelength but allows light of other wavelengths to pass therethrough. Laser light is reflected towards the focusing lenses 176, 177 and light that is collected by the scanning optics that is not of the laser wavelength is transmitted to measuring aperture 171.

The optical module 106 further comprises a heat dump 181 for capturing laser light that is transmitted through the beam splitter 178.

Various measuring devices can be connected to the measuring aperture 171. In this embodiment, a camera 173 and a photodiode measurement arrangement 172 are provided for measuring the radiation collected by the optical scanner. The photodiode measurement arrangement 172 comprises a first photodiode 172A and a second photodiode 172B which in this embodiment are configured to detect different wavelengths. A further beam splitter 185 splits the radiation deflected into aperture 171 to direct a proportion of the radiation to the photodiode measurement arrangement 172 and a proportion to camera 173.

The photodiode measurement arrangement 172 provides a measurement of the light emitted from the build area 122 that is exposed to the laser beam and camera 180 captures an image of this region.

In use, the computer 130 controls the laser 105 and the optical module 106 to scan the laser beam across build area 122 in order to solidify selected areas of a powder layer forming part of a powder bed 104 during formation of an object based upon geometric data stored on the computer 130.

In a first embodiment a laser beam is used to scan the entire build area 122 and photodiode measurement arrangement 172 can be used to record the lasers' interaction with the build area 122. In this embodiment the laser wavelength is approximately 1080 nm, the first photodiode 172A is configured to detect wavelengths in the range 700 nm to 1050 nm and the second photodiode is configured to detect wavelengths in the range 1100 nm to 2000 nm. In the current embodiment only the first photodiode 172A is required to record the optical process emissions from the bed generated by the laser's interaction from the bed. The optical process emissions in the current embodiment are of a shorter wavelength than the laser wavelength. Therefore, in this embodiment the first photodiode 172A is indirectly monitoring the intensity of the laser on the build area 122. By scanning the entire build area 122 with the laser, all locations of the build chamber window 107 through which the laser enters the build chamber 101 can be assessed for damage. The data recorded during this process can be filtered for areas giving rise to low intensity readings of the laser's interaction with the build area 122 which can be used to assess the build chamber window 107 for damage as will be explained in more detail below in relation to a second embodiment.

In a second embodiment the invention is described in relation to a multilaser machine, in particular an additive manufacturing apparatus comprising four lasers.

In this embodiment, four lasers can enter the build chamber through a single build chamber window 107, it will be understood that in other embodiments the laser beams may enter through a plurality of windows in the build chamber. Each laser can be directed towards the build area 122 by an optical module 106 in order to consolidate build material within the build area 122 during manufacture of an object 103, therefore the interaction of each laser with the build area 122 can be monitored by an on-axis photodiode measurement arrangement 172 and/or camera 173.

A method 200 of determining damage to a build chamber window 107 will now be described with reference to FIG. 5.

In a first step 210 the build area 122 is partitioned into a plurality of sets of scan zones. In combination the plurality of sets of scan zones cover the entire build area. In this embodiment the build area 122 is partitioned into the same number of sets of scan zones as there are lasers in the additive manufacturing apparatus, i.e., into four sets of scan zones. FIG. 6A shows a first set of scan zones 302, FIG. 6B shows a second set of scan zones 304, FIG. 6C shows a third set of scan zones 306, and FIG. 6D shows a fourth set of scan zones 308. Each set of scan zones 302, 304, 306, 308 represents one quarter of the total build area. Within each set of scan zones 302, 304, 306, 308, no two scan zones share a common edge, for example as can be seen in FIG. 6A scan zone 302A does not share a common edge with any of scan zones 302B, 302C, or 302D, scan zone 302B does not share a common edge with any of scan zones 302C, or 302D, and scan zones 302C and 302D do not share a common edge.

In a second step 220 the build area 122 is scanned by each laser and the results recorded using the photodiode measurement arrangement 172. In order for step 220 to be carried out efficiently, in the current embodiment all four lasers are used simultaneously. The build area 122 is scanned four times, during each scan of the build area 122 each laser scans one quarter of the build area 122.

In a first scan of the build area 122, a first laser scans the first set of scan zones 302, a second laser scans the second set of scan zones 304, a third laser scans the third set of scan zones 306, and a fourth laser scans the fourth set of scan zones 308. In a second scan of the build area 122, the second laser scans the first set of scan zones 302, the third laser scans the second set of scan zones 304, the fourth laser scans the third set of scan zones 306, and the first laser scans a fourth set of scan zones 308. In a third scan of the build area 122, the third laser scans the first set of scan zones 302, the fourth laser scans the second set of scan zones 304, the first laser scans the third set of scan zones 306, and the second laser scans a fourth set of scan zones 308. In a fourth scan of the build area 122, the fourth laser scans the first set of scan zones 302, the first laser scans the second set of scan zones 304, the second laser scans the third set of scan zones 306, and the third laser scans a fourth set of scan zones 308. Once all four scans of the build area 122 have been completed, each of the first, second, third, and fourth lasers have scanned the entire bed and a record for each of the first, second, third, and fourth laser beams' interaction with the entire bed has been obtained by the photodiode measurement arrangement 172.

When a laser beam enters the build chamber 101 through the build chamber window 107 if there is damage to the build chamber window 107 (for example contamination of the build chamber window 107 or a crack or other defect in the build chamber window 107), the build chamber window 107 can absorb more of the laser energy compared to an undamaged window. The extra energy absorbed by the build chamber window 107 can cause a local deformation of the window, for example localised swelling of the build chamber window 107 which can cause the laser beam to be defocussed and/or cause the laser beam's path to be altered (thermal lensing). This can cause the energy density of the laser beam on the build area 112 to fall. A drop in laser beam energy density on the build area 112 can cause a drop in the amount of plasma or reduction in other process emissions created by the laser beam interacting with the material in the build area. The photodiode measurement arrangement 172 will therefore register a lower intensity signal due to a reduced amount of process emissions generated in the area monitored by the photodiode measurement arrangement 172. As part of the method, it can be advantageous to scan the laser beam across the build area 112 using small stripes in close proximity to one another in order to provoke localised heating of the build chamber window 107 in the vicinity of the defect. This can be achieved in the current embodiment by raster scanning the laser beam across each scan zone, for example for scan zone 308C shown in FIG. 6D, the scan zone 308C is scanned starting in one corner of the rectangular scan zone (in a raster fashion) in stripes parallel to the short edge of the rectangular scan zone. In a third step 230 data relating to low intensity signals is identified.

The raw data obtained by the process monitoring devices in this embodiment comprises photodiode and power value signals. Laser performance may vary from laser to laser, for example due to tolerances in performance, in other words each laser may be instructed to operate at the same power throughout the method but there may be a variation in power achieved between the lasers. In addition, each laser is associated with a photodiode measurement arrangement 172, and each photodiode measurement arrangement 172 may have a slightly different response to the same stimuli, this can be at least in part due to each photodiode having a unique gain value. It may be useful to normalise the photodiode signal to the power value to allow direct comparisons between datapoints in the datasets.

The data shown in FIGS. 7 to 13 illustrate the method of the current embodiment and are generated using a titanium plate located on the platform 102. Raster scanning of the scan zones was carried out by the plurality of laser beams as described above. The scan parameters were, point distance=75 μm, exposure time=50 μs, scan speed=1.25 m/s, hatching space 65 μs. Data was collected using the first photodiode 172A monitoring the process emissions generated by the interaction of the laser beam with the titanium plate.

In this embodiment data is collected at a 100 kHz native capture rate and comprises data relating to x-position, y-position, focus, and photodiode readings synchronised with laser energy.

The intensity data for each laser beam is normalised to give a mean of zero by calculating its z-score and the data is measured in numbers of standard deviations from the mean.

The equation for calculating the z-score is:

$$Z = \frac{x - μ}{σ}$$

where x refers to the intensity value of the pixel here, μ is the overall mean intensity and σ is the standard deviation.

Performing the z-score on the photodiode data allows for direct comparisons between photodiode signals. FIG. 7 shows an example of the z-score data for the fourth set of scan zones 308 for a particular layer (i.e., all scan zones 308A, 308B, 308C, 308D are scanned by the same laser).

After the raw data has been normalised it is computationally beneficial to reduce the dataset by accumulating or smoothing the data. The data is partitioned into a two-dimensional grid of pixels, for example each pixel may be a square of side 200 μm. As will be understood, each 200 μm pixel will contain multiple datapoints from multiple hatch lines of the scan. For each pixel the mean of all the intensity values of the datapoints belonging to it is calculated (in other embodiments the sum, or maximum, or another value may be used). In other words, values are accumulated by a spatial partition. FIG. 7 shows an example of the accumulated data set for the fourth set of scan zones 308 for a particular layer (i.e., all scan zones 308A, 308B, 308C, 308D are scanned by the same laser).

A filter −tσ is applied to the z-score data of the accumulated data set so that only data below the tolerance t multiple of the negative standard deviation is kept. The lower bound filter parameter t is an input parameter and may be user defined. In the current embodiment a value of 2 is used for t. The value of t may be set by a user. The value of t can vary between different materials, this is because the process emissions (such as plasma) generated by the interaction of the laser beam and the build area vary between different materials and so the value of t may need to be adjusted accordingly.

FIG. 8 shows the remaining data after the filter has been applied to the z-score data of FIG. 7. The data remaining after application of the filter represents the locations of the build area 122 where the lowest intensity was registered by the measurement device(s) 172, 173. The remaining data shown in FIG. 8 can be grouped into islands of data, including 402, 404, 406. However, not all the remaining data may indicate damage to the build chamber window 107, and the remaining data can be cleaned up to remove noise.

A density-based spatial clustering of applications with noise (DBSCAN) algorithm is applied to the remaining data in order to isolate dense defect regions in the remaining data from background noise. The DBSCAN method finds clusters in the data by looking at the number of neighbours within a defined vicinity of each datapoint. The clustering result is dependent on two input parameters, epsilon—the radius searched around each point, and minpts—the minimum number of points within this radius to start identifying a cluster.

Each datapoint is labelled as one of three types of point:
core point—contains at least minpts number of points within epsilon of the datapoint
border point—reachable from a core point but has fewer than minpts within its radius
outlier—not a core point and not reachable from any core point

The DBSCAN algorithm can comprise the following steps:
For each point in the dataset, find all its neighbours within epsilon
If the number of neighbours is:
   Less than minpts, identify this point as an outlier
   More than minpts, identify this point as a core point
      If the points within epsilon of the core point are:
         Already labelled as an outlier, re-label as part of this cluster
         Undefined, label as part of this cluster if it is also a core point, add its neighbours to this cluster
Proceed to the next undefined point

In other words, the DBSCAN algorithm used in this embodiment performs depth-first searches from core points.

After performing the DBSCAN algorithm on the filtered data, two clusters are found in this example which are differentiated from background noise. FIG. 9A shows data which the algorithm has grouped into clusters, including clusters 402, 404. FIG. 9B shows the data which has been determined by the algorithm to be noise by applying a threshold, including data island 406, which is based on a spatial extent of the cluster(s). This threshold is proportional to the beam diameter on the window, for example in the current embodiment data islands having a spatial extent smaller than the laser beam diameter on the build chamber window are considered to be noise.

In a fourth step 240 of the method the location(s) where a laser passes through the build chamber window 107 which are associated with low intensity signal clusters is identified. FIG. 10 shows a projection of where the laser beam passes through the build chamber window 107 in order to reach the clusters 402, 404 on the build area 122. In the figure, a laser position 575 is shown, this laser position 575 relates to the location where the laser beam is directed towards the build area 122, in this embodiment the laser position 575 is taken to be the centre point of a tiltable mirror which is used to project the laser beam through an exit aperture in the optical module (for example, the centre of tiltable mirror 175 used to project the laser beam through aperture 174 of an optical module 106). By knowing the laser beam position (approximated to the centre of the beam director optics which in this embodiment is the centre of a tiltable mirror) and distance relative to the build area 122, it is possible to calculate the route the laser takes from the optical module to the build area 122. The locations on the build chamber window 107 through which the laser passes when locations of the build area 122 corresponding to clusters 402, 404 can be calculated because the relative positions of the build area 122, build chamber window 107, and optical module are known. In the example shown in FIG. 10, the laser passes through the build chamber window at 502 when illuminating the part of the build area 122 corresponding to cluster 402, and the laser passes through the build chamber window 107 at 504 when illuminating the part of the build area 122 corresponding to cluster 404.

While FIG. 7 showed the data for one laser for a particular layer, FIG. 11 shows data for all four lasers for the particular layer. FIG. 11 shows data collected for three different laser powers, FIG. 11A shows data collected when a 300W laser beam is used, FIG. 11B shows data collected when a 200W laser beam is used, and FIG. 11C shows data collected when a 150W laser beam is used. FIG. 11 also shows clusters of data identified on the build area 122 using the method described above. As can been seen from FIG. 11, all three laser powers (300W, 200W, and 150W) generated data which allowed identification of the same clusters of points on the build area 122.

In particular, FIG. 11 shows the data for scan zone 308D including the lower intensity data collected which relates to cluster 402 (FIG. 9A). As can be seen in FIG. 11 (for example, FIG. 11B) the lower intensity data relating to cluster 402 is confined to scan zone 308D, i.e. the lower intensity data relating to cluster 402 does not continue across the border between scan zones 308D and 306D. The discontinuation at the border between scan zones is indicative of damage to the build chamber window 107, this is because the laser scanning scan zone 308D and the laser scanning scan zone 306D pass through the build chamber window 107 at different locations on the build chamber window 107 and so localised damage to the build chamber window 107 may not be present at both points of laser entry through the build chamber window 107. If however the low intensity data did continue across the border between two adjacent scan zones, this could be indicative of a problem on the build area 122 rather than the build chamber window 107. By increasing the number of scan zones such that adjacent scan zones which share a common edge are processed by different lasers (for example having more scan zones than the number of lasers) it is possible to increase the likelihood of observing a discontinuation of a low intensity region at a border between scan zones if there is damage to the build chamber window, and thus confidence in assigning the low intensity data to damage to the build chamber window 107 can be increased. It is also possible to identify defects that are on the build area rather than the build chamber window 107 by comparing two sets of data for the same scan zone but which have been generated using different laser beams. If both sets of data contain the same (or similar) defect, this is indicative of the defect being related to the build area.

FIG. 12 shows the clusters of FIG. 11 projected onto the build chamber window 107. It is possible to check the results of the above described analysis to check for damage of the build chamber window. The image of FIG. 12 can be printed out at an appropriate scale and directly compared to the build chamber window. FIG. 13 shows such a comparison of FIG. 12 and the build chamber window. As can be seen in FIG. 13 a crack 602 is present in the build chamber window 107 and is well aligned with the projection of cluster 402 onto the build chamber window 107.

In the above described embodiment, the data collected was using a titanium build plate located on the build platform 102. However, this need not be the case, and in other embodiments the build platform 102 may be directly scanned, or in still further embodiments each layer of the scan may be performed on an uppermost layer of powder of the powder bed 104, for example a separate powder layer for each scan layer.

While the embodiments described above have used an on-axis monitoring system comprising at least one photodiode to monitor laser interaction with the build area, in other embodiments this need not be the case and monitoring systems located off-axis may be used, for example a camera located within the build chamber. Other embodiments may not use the DBSANC algorithm but may use other clustering algorithms as known to the skilled person. Further embodiments may emit the use of a clustering algorithm.

1. A method of detecting damage of a build chamber window of an additive manufacturing apparatus, the additive manufacturing apparatus comprising a build chamber comprising the build chamber window through which an energy beam may enter the build chamber, and a build area where a build medium can be located to be consolidated by the energy beam, the method comprising monitoring the intensity of process emissions from the build area.

2. The method according to claim 1 wherein the process emissions are monitored by a sensor, wherein the optical path of radiation collected by the sensor from the build area is at least partially coincident with the path of the energy beam.

3. The method according to claim 2 comprising comparing data collected by the sensor from locations of the build area to a threshold value.

4. The method according to claim 3 wherein the data is at least one of (i) a normalised data set, and/or (ii) spatial extent of data, and/or (iii) density of defects.

5. The method according to claim 1 wherein the method is carried out prior to building a part, optionally the method comprises determining a “go/no-go” state for building a part.

6. The method according to claim 1 comprising rearranging locations of a part to be built within the build area in response to detected damage of the build chamber window.

7. The method according to claim 1 comprising monitoring the intensity of process emissions created by a plurality of energy beams on the build area.

8. The method according to claim 7 comprising changing the allocated energy beam used for building a part or a section of a part in response to detected damage of the build chamber window.

9. The method according to claim 7 comprising monitoring the intensity of process emissions created by a plurality of energy beams for the same part of the build area.

10. The method according to claim 2 comprising scanning the energy beam across the build area in a pattern for causing localised heating of a build chamber window.

11. A method of manufacturing a product comprising layer-by-layer consolidation by an energy beam of a build material in a build area located within a build chamber, the build chamber comprising a build chamber window through which the energy beam may enter the build chamber and a build area where the build medium can be located to be consolidated by the energy beam, the method comprising monitoring the process emissions from the build area.

12. An additive manufacturing apparatus comprising a device for generating an energy beam for consolidating a build medium and a build chamber, the build chamber comprising a build chamber window through which the energy beam may enter the build chamber and a build area where the build medium can be located to be consolidated by the energy beam, wherein the additive manufacturing apparatus is configured to monitor process emissions from the build area to detect damage of the build chamber window.

13. The additive manufacturing apparatus according to claim 12 wherein the additive manufacturing apparatus comprises a device for monitoring the intensity of the process emissions.

14. The additive manufacturing apparatus according to claim 13 configured to identify locations of the build area where the intensity of the process emissions is below a threshold value.
